(19) United States
(12) Patent Application Publication
(10) Pub. No.: US 2005/0207927 A1
(43) Pub. Date: Sep. 22, 2005

(54) Gear pump

(76) Inventors: Johnny Farm, Hagersten (SE); Hans Jonsson, Sodertalje (SE)

Correspondence Address: OSTROLENK FABER GERB & SOFFEN, 1180 AVENUE OF THE AMERICAS, NEW YORK, NY, 100368403, US

(21) Appl. No.: 10/516,857

(22) PCT Filed: Jun. 13, 2003
(86) PCT No.: PCT/SE03/00986

§ 371 Date: Dec. 3, 2004

(30) Foreign Application Priority Data
Jul. 3, 2002 (SE) 0202084-0

(51) Int. Cl. F01C 1/24; F04C 18/00; F03C 2/00; F03C 4/00

(52) U.S. Cl. 418/204

(57) ABSTRACT

A gear pump incorporates a ring gear supported for rotation, a gearwheel arranged eccentrically within the ring gear, and a rotatable shaft incorporating a portion which extends through a hole in the gearwheel. The portion of the shaft includes a first surface, and the gearwheel includes a second surface, which surfaces are shaped to allow transfer of rotary motion from the shaft to the gearwheel. The transfer between the first surface and the second surface takes place via a region of contact. The region of contact has axial extent equal to less than half of the gearwheel's axial extent and the region is divided by a radial plane which extends centrally through the gearwheel.

### BACKGROUND TO THE INVENTION, AND STATE OF THE ART

The invention relates to a gear pump according to the preamble of claim 1.

Gear pumps are used inter alia in hydrodynamic brakes, e.g. in retarders in vehicles. The gear pump is driven by a rotatable shaft which is connected to the vehicle's driveline. The gear pump thus transfers oil substantially continuously from an oil sump when the vehicle is in operation. The oil is transferred to a toroidal space (defined by the retarder's stator and rotor) when braking action of the retarder is desired, but bypasses the toroidal space when no braking action of the retarder is required.

The rotatable shaft incorporates a portion which extends through a central hole in the gearwheel. Said portion of the shaft incorporates a heel-shaped recess. The gearwheel incorporates a corresponding heel-shaped portion which protrudes into the hole. The heel-shaped recess in the shaft incorporates a planar surface which in the assembled state is designed to abut against a corresponding planar surface of the heel-shaped portion of the gearwheel. By means of the cooperating planar surfaces, the rotary motion of the shaft is converted to a corresponding rotary motion of the gearwheel. The cooperating planar surfaces which are in engagement with one another have an extent along the whole width of the gearwheel. Insufficient matching of said surfaces to one another or imperfect shape fit of the surfaces may in unfavourable circumstances result in the rotary motion being transmitted on a relatively limited region where said surfaces first come into contact with one another. This motion-transmitting region may be situated at a distance from the axial centre of the gearwheel. This causes risk of uneven stressing of the gearwheel. Uneven stressing of the gearwheel results in unnecessary wear and the risk of the gearwheel overturning.

### SUMMARY OF THE INVENTION

The object of the present invention is to provide a gear pump in which the constituent rotatable shaft and the gearwheel exhibit cooperating surfaces which have a shape which substantially eliminates any risk of the gearwheel being unevenly stressed during operation of the rotatable shaft.

This object is achieved with the gear pump of the kind mentioned in the introduction which is characterised by the features indicated in the characterising part of claim 1. The region of contact between the shaft and the gearwheel in this case is deliberately made substantially narrower than the width of the gearwheel and is concentrated in the axial middle portion of the gearwheel. Even if the shape fit of the surfaces which form the region of contact is imperfect, transfer of motion between the shaft and the gearwheel will take place within at least the intended region of contact. With advantage, the region of contact has an axial extent which is less than one-quarter of the width of the gearwheel. As the region of contact is relatively limited and is situated substantially centrally, any local transfer of motion cannot take place within the region of contact at a particularly large distance from said radial plane which extends centrally through the gearwheel. The risk of uneven stressing of the gearwheel is thus substantially eliminated.

According to a preferred embodiment of the present invention, said radial plane divides the region of contact into two substantially equal areas. Such an entirely centred region of contact with respect to the gearwheel further eliminates the risk of the gearwheel being unevenly stressed. Similar exacting requirements concerning the manufacturing tolerances for the surfaces of the shaft and gearwheel via which the transfer of motion takes place are thus obviated since the transfer of motion will in all circumstances take place very close to said radial plane which extends centrally through the gearwheel.

According to another preferred embodiment of the present invention, said first surface is incorporated in a recess of the shaft. Such a recess may for example be cut out of the surface of the shaft. Said second surface may be incorporated in a portion of the gearwheel which extends radially inwards into said hole. A gearwheel thus formed, with a portion which extends radially inwards in the gearwheel's hole, may for example be made by sintering. The recess in the shaft preferably has a shape which corresponds to and therefore accommodates the gearwheel portion extending inwards. The first surface of the shaft and the second surface of the gearwheel need to have an angle of inclination which provides firm engagement between the surfaces in order to allow said transfer of rotation.

According to another preferred embodiment of the present invention, said second surface has a substantially planar extent in an axial direction and said first surface a curved extent in an axial direction so that said region of contact is constituted. The gearwheel portion thus incorporates here a first surface with a planar shape, whereas the shaft recess incorporates a second surface with a curved shape which allows only the area of the first curved surface which abuts centrally against the planar second surface of the gearwheel to achieve contact during a transfer of motion and form said region of contact. With advantage, the first surface has a curved extent beyond the region of contact so that the distance between the first surface and the second surface increases in proportion to the distance from the region of contact. This means that any wear of the first and second surfaces makes it possible for the size of the region of contact to increase somewhat, but such curvature ensures that the region of contact will not encompass the surfaces which are situated at a greater distances from the axial middle plane of the gearwheel. The risk of uneven stressing thus increases only marginally with wear of the contact surfaces.

According to an alternative embodiment of the present invention, said first surface has a planar extent in an axial direction and said second surface has a curved extent in an axial direction with a shape such that said region of contact is constituted. In this case the shaft recess incorporates a planar first surface, whereas the gearwheel portion incorporates a second curved surface with a shape which allows only a central area of the gearwheel to abut against the second surface of the shaft and form said region of contact. In a manner corresponding to the above, the second surface may have a curved extent beyond the region of contact so that the distance between the first surface and the second surface increases in proportion to the distance from the region of contact. Corresponding advantages concerning worn contact surfaces also apply in this case. The narrower the region of contact, the greater will be the stressing of the first and second surfaces in this region.

According to another preferred embodiment of the present invention, the gear pump is arranged in a hydrodynamic brake and is intended to pump a medium from a storage space. A gear pump comprises a small number of parts and occupies relatively little space. It is therefore advantageous to use such a pump for transferring oil in a retarder of a vehicle. It is advantageous that the hydrodynamic brake should have a structure with a multiplicity of recesses which each have an opening in a substantially common plane and that the gear pump be intended to be arranged in one of said recesses. Such positioning makes the gear pump readily accessible for fitting and removal.

### BRIEF DESCRIPTION OF THE DRAWINGS

Preferred embodiments of the invention are described below by way of examples with reference to the attached drawings, in which:

FIG. 1 depicts a section of a retarder which incorporates a gear pump,

FIG. 2 depicts a gear pump,

FIGS. 3a-b depict a shaft of a gear pump according to a first embodiment,

FIGS. 4a-b depict a gearwheel of a gear pump according to a first embodiment,

FIGS. 5a-b depict a shaft of a gear pump according to a second embodiment and

FIGS. 6a-b depict a gearwheel of a gear pump according to a second embodiment.

### DETAILED DESCRIPTION OF PREFERRED EMBODIMENTS OF THE INVENTION

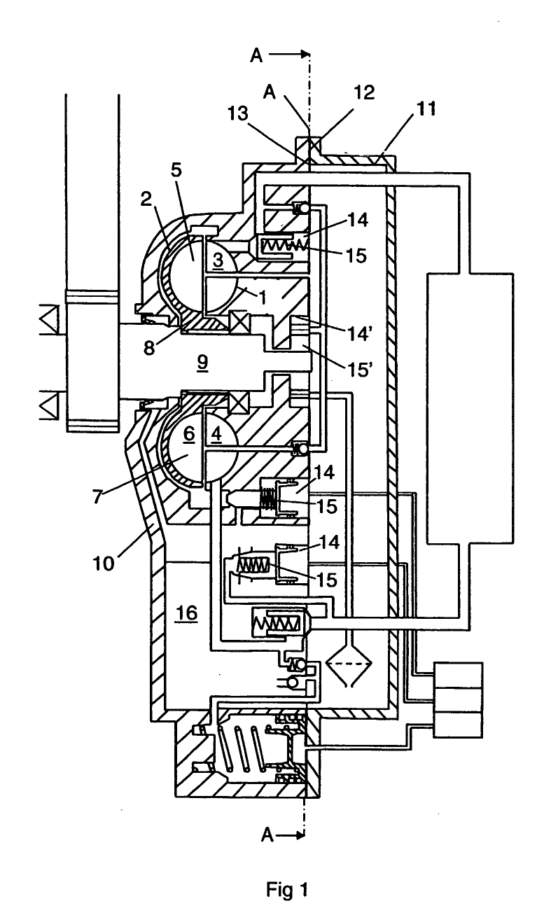

FIG. 1 depicts a hydrodynamic brake in the form of a retarder of a powered vehicle. The retarder comprises a stator 1 and a rotor 2. The stator 1 has an annular shell 3 with a multiplicity of blades 4 arranged at uniform spacing along the annular shell 3. The rotor 2 has a corresponding annular shell 5 which incorporates a multiplicity of blades 6 likewise arranged at uniform spacing along the annular shell 5. The respective shells 3, 5 of the stator 1 and rotor 2 are coaxially arranged with respect to one another so that they together form a toroidal space 7. The rotor 2 incorporates a shaft portion 8 which is connected firmly to a rotatable shaft 9. The rotatable shaft 9 is itself connected to an appropriate driveshaft of the vehicle's driveline. The rotor 2 will thus rotate together with the vehicle's driveline.

The retarder depicted in FIG. 1 incorporates a housing which consists of a first element 10 and a second element 11. The first element 10 incorporates a body in which inter alia the stator 1 and the rotor 2 are arranged. The second element 11 has a cover-like structure and is detachably fittable along a connecting region 12 to the first element 10 so that in a fitted state they form a closed housing. A gasket 13 is arranged in the connecting region 12 so that the housing forms a sealed enclosure. The first element 10 incorporates a number of recesses 14 to accommodate various components 15 of the retarder. The shape and size of the recesses 14 are appropriate to the specific components 15 which they accommodate. Such a recess 14′ accommodates a gear pump 15′. The recesses 14 each have an opening in a substantially common plane A. The broken line A-A in FIG. 1 represents said plane A. The connecting region 12 of the first element 10 and second element 11 also has an extent in said plane A. Such positioning renders the components 15, including the gear pump 15′, readily accessible for fitting and removal. The gear pump 15′ is driven by the rotatable shaft 9. This means that the gear pump 15′ runs continuously while the vehicle is in operation. The gear pump 15′ thus transfers oil from an oil sump 16 to the toroidal space 7 when braking action is required of the retarder, and to a pipe circuit bypassing the toroidal space 7 when no braking action is required of the retarder.

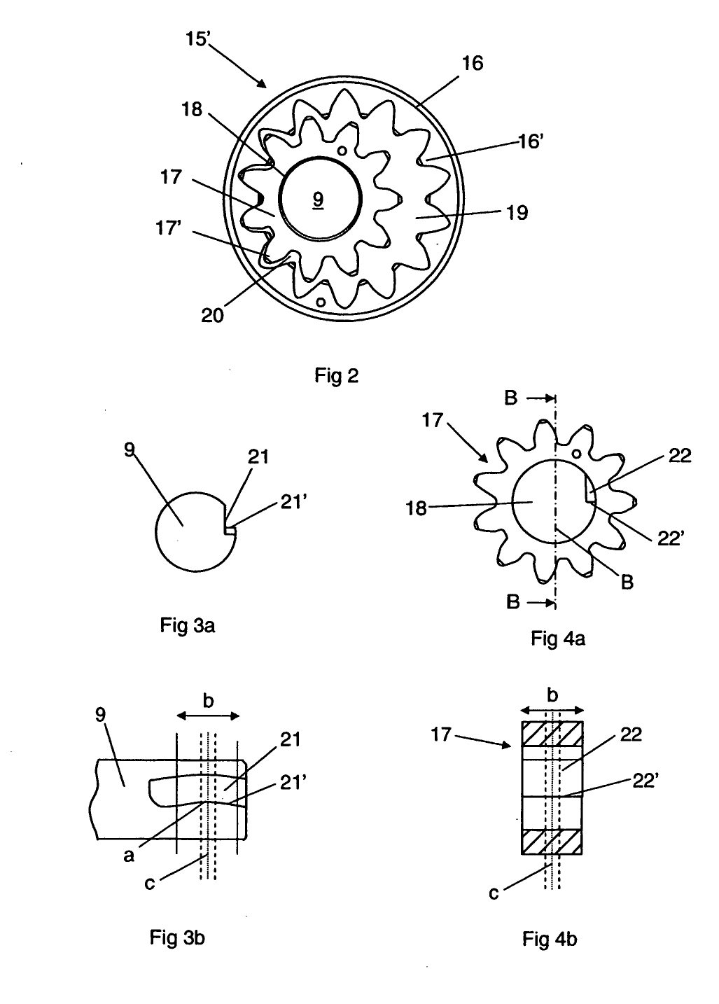

FIG. 2 depicts a gear pump 15′ in more detail. The gear pump 15′ incorporates a ring gear 16 which is supported for rotation and which is provided with a multiplicity of internal teeth 16′. A gearwheel 17 is arranged excentrically within the ring gear 16 and incorporates external teeth 17′ which are in engagement with the ring gear's internal teeth 16a. A portion of the rotatable shaft 9 extends through a central hole 18 in the gear wheel 17. The rotatable shaft 9 and the gearwheel 17 are connected together so that a rotary motion from the shaft 9 is transmitted to the gearwheel 17. The gearwheel 17 itself transfers said rotary motion to the ring gear 16. In the space between the ring gear 16 and the gearwheel 17 there are a low-pressure side 19 with an inlet pipe for the oil and a high-pressure side 20 with an outlet pipe for the oil. The inlet pipe and outlet pipe are not depicted in the drawing, since the arrangement of such pipes in connection with a gear pump 15′ is conventional technology. When the gearwheel 17 and the ring gear 16 rotate, oil will be drawn from the low-pressure side 19 to the high-pressure side 20, thereby imparting to the oil an increased pressure due to the gradually reduced space between the teeth 16′, 17′. The pressurised oil is transferred to the toroidal space 7 when a braking action is required or to a pipe circuit which leads past the toroidal space 7 when no braking action is required.

FIG. 3a depicts a front view of the rotatable shaft 9 of the gear pump 15′, and FIG. 3b a side view of the rotatable shaft 9. The rotatable shaft 9 incorporates a recess 21 with a first surface 21′. The first surface 21′ has a curved extent in an axial direction. The axial extent of the first surface 21′ exceeds the width b of the gearwheel 17. The curved first surface 21′ constitutes a convex shape with a region of contact a which forms a substantially central protruding portion in the direction of rotation of the shaft 9′. The region of contact a has an axial extent which is at least equal to less than half of the width b of the gearwheel 17. With advantage, the region of contact a has an axial extent which amounts to 15-25% of the width b of the gearwheel 17. In the drawings, the boundaries of the region of contact a are represented by broken lines. A radial plane c which extends centrally through the gearwheel divides the region of contact in two substantially equal areas. The radial plane c is represented by a dotted line in the drawings.

FIG. 4a depicts a front view of only the gearwheel 17 of the gear pump 15′, and FIG. 3b a sectional view of the gearwheel 17 along a plane B which is defined by the line B-B in FIG. 4a. The gearwheel 17 incorporates a portion 22 which extends radially inwards in the gearwheel's central hole 18. The portion 22 incorporates a second surface 22′. The second surface 22′ has a planar extent in an axial direction along the whole width b of the gearwheel 17. The gearwheel's portion 22 has a shape which allows accommodation in the shaft recess 21 so as to allow transmission of the shaft's rotary motion to the gearwheel 17 via the first surface 21′ and the second surface 22′. The curved shape of the first surface 21′ results in only the region of contact a of the first surface 21′ coming into contact with the second surface 22′ of the gearwheel portion 22. The position of the region of contact a of the first surface 21′ is such that its midpoint is situated in the radial plane c which extends centrally through the gearwheel 17. The region of contact a is thus symmetrically arranged on both sides of said plane c. The first surface 21′ has a curved extent beyond the region of contact a so that the distance between the first surface 21′ and the second surface 22′ increases in proportion to the distance from the region of contact a.

During operation of the shaft 9, the region of contact a of the first surface 21′ comes into contact with the gearwheel's second surface 22′. The region of contact a is thus substantially narrower than the width b of the gearwheel 17 and is concentrated in the region round the axial centre of the gearwheel 17. Even if the shape fit of the first surface 21′ and the second surface 22′ is not entirely optimum, the motions of the shaft 9 are nevertheless guaranteed to be transmitted to the gearwheel 17 via part of the region of contact a. As the region of contact a has a relatively limited width and is situated centrally relative to the gearwheel 17, any such local transmission within the region of contact a will take place at a relatively limited distance from said radial plane c which extends centrally through the gearwheel. This means that the risk of uneven stressing of the gearwheel 17 is substantially non-existent.

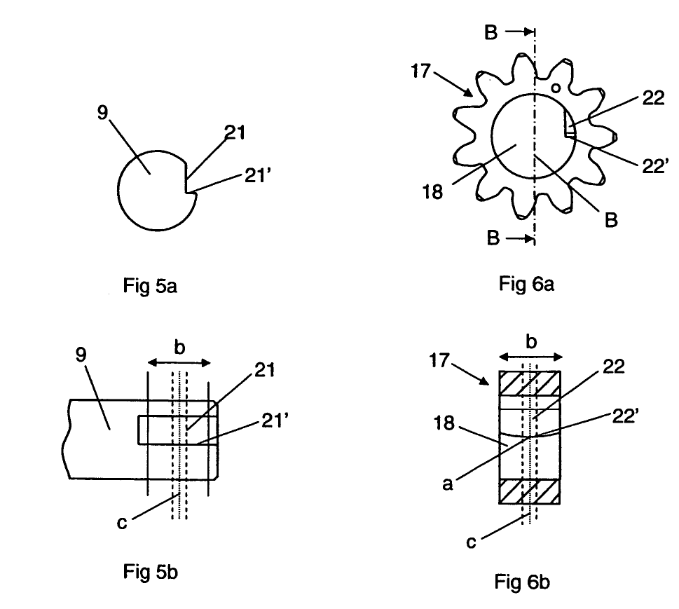

FIGS. 5a and 5b depict a rotatable shaft 9 with an alternatively shaped recess 21. In this case the recess 21 has a first surface 21′ with a substantially planar extent in an axial direction. FIGS. 6a and 6b depict a gearwheel 17 with an alternatively shaped portion 22. In this case the portion 22 has a second surface 22′ with a curved extent in an axial direction along the whole width b of the gearwheel 17. The curved second surface 22′ has a convex shape with a region of contact a constituted by a substantially central protruding portion directed against the direction of rotation of the gearwheel 17. The region of contact a has an axial extent which in this case corresponds to about 15-25% of the gearwheel's width b. The second surface 22′ has a curved extent beyond the region of contact so that the distance between the first surface 21′ and the second surface 22′ increases in proportion to the distance from the region of contact.

During operation of the shaft 9 in this case the planar first surface 21′ comes into contact with the region of contact a of the second surface 22′ of the gearwheel 17. The region of contact a is thus substantially narrower than the width b of the gearwheel 17 and is at the same time concentrated on a region round the centre of the gearwheel 17. Even if the shape fit of the first surface 21′ and the second surface 22′ is not entirely optimum, the motions of the shaft 9 are nevertheless guaranteed to be transmitted to the gearwheel 17 via part of the region of contact a. As the region of contact a is relatively narrow and is arranged centrally on the gearwheel, such local transmission within the region of contact a will be guaranteed to take place at a relatively limited distance from said radial plane c.

The invention is in no way limited to the embodiment described but may be varied freely within the scopes of the claims. The first and second surfaces may have substantially any desired shapes provided that they jointly constitute a region of contact situated centrally with respect to the gearwheel. The example has been described with reference to a retarder in a vehicle but the invention may be utilised analogously in all applications where corresponding problems and requirements arise both within the area of vehicle technology and within other areas where gear pumps are relevant.

1. A gear pump comprising:
a ring gear supported for rotation, having an open center region, and having internal teeth projecting into the center region;
a gearwheel arranged eccentrically within the center region of the ring gear and including external teeth intended to engage with the ring gear internal teeth the gearwheel having a hole through it, the gearwheel having an axial extent;
a rotatable shaft including a portion which extends through the hole in the gearwheel; the portion of the shaft includes a first surface and the gearwheel includes a second surface, the first surface and the second surface are shaped to allow transfer of rotary motion from the shaft to the gearwheel, and a transfer between the first surface and the second surface takes place via a region of contact which has an axial extent less than half of the gearwheel axial extent and the region is divided by a radial plane which extends centrally through the gearwheel.

2. A gear pump according to claim 1, wherein the radial plane is located so it divides the region of contact into two substantially equal areas.

3. A gear pump according to claim 1 further comprising a recess in the shaft in which the first surface is included.

4. A gear pump according to claim 1, wherein the second surface is included in a portion of the gearwheel which extends radially inwards in the gearwheel hole.

5. A gear pump according to claim 1, having an open center region, the second surface has a substantially planar extent in an axial direction and the first surface has a curved extent in an axial direction and shaped to define the region of contact.

6. A gear pump according to claim 5, wherein the first surface has a curved extent beyond the region of contact causing the distance between the first surface and the second surface to increase in proportion to the distance out from the region of contact.

7. A gear pump according to claim 1, wherein the first surface has a planar extent in an axial direction and that the second surface has a curved extent in an axial direction with a shape to define the region of contact.

8. A gear pump according to claim 7, wherein the second surface has a curved extent beyond the region of contact so that the distance between the first surface and the second surface increases in proportion to the distance out from the region of contact.

9. (canceled)

10. A hydrodynamic brake according to claim 11, wherein the hydrodynamic brake further comprises a structure with a multiplicity of recesses for accommodating various components of the brake, each of the recesses has an opening in a substantially common plane, and the gear pump is arranged in one of the recesses.

11. A hydrodynamic brake comprising a stator with blades, a rotor with blades, and the rotor and stator defining a working space to receive a medium, an inlet and an outlet from the working space; a storage space for the medium and connected to the inlet to the space; and
the gear pump of claim 1 between the working space and the inlet, the pump being operable for transferring medium from the space to the working chamber.
